(19) United States
(12) Patent Application Publication
(10) Pub. No.: US 2021/0277902 A1
(43) Pub. Date: Sep. 9, 2021

(54) REGENERATIVE PUMP START AND ACTUATION STAGE FOR HIGH-SPEED CENTRIFUGAL FUEL PUMP

(71) Applicant: EATON INTELLIGENT POWER LIMITED, DUBLIN (IE)

(72) Inventors: Cody M. Mackey, Mentor, OH (US); Martin A. Clements, Loveland, OH (US)

(73) Assignee: EATON INTELLIGENT POWER LIMITED

(21) Appl. No.: 17/192,458

(22) Filed: Mar. 4, 2021

Related U.S. Application Data
(60) Provisional application No. 62/984,913, filed on Mar. 4, 2020.

(51) Int. Cl. F04D 5/00; F04D 15/00

(52) U.S. Cl. CPC F04D 5/003; F04D 15/0005; F04D 5/007

(57) ABSTRACT

A fuel pump system (100) and associated method for supplying fuel from an associated fluid source (112) to an associated downstream use (102, 104) including for engine (i) start mode, (ii) run mode, and (iii) actuation mode are disclosed. The system has a pump (110) including a primary stage (116) having an inlet (114), and an outlet (120) that is configured to selectively supply pressurized flow for the (ii) run mode, and a regenerative stage (130) commonly driven with the primary stage to selectively provide pressurized fluid for the (i) start mode and the (iii) actuation mode.

### BACKGROUND

This invention relates pump systems, and particularly pump systems used in connection with modern day jet engine fuel systems.

Centrifugal type fuel pumps are ideal for application in a modern day jet engine fuel system if the limitation of starting the engine is properly addressed. A centrifugal pump produces pressure as a function of the rotating speed squared. In a typical centrifugal pump application, insufficient pump output pressure is generated to start the engine when the pump is rotated at typical starting speeds (i.e., less than around 20 to 30% of operating speed where operating speed is, for example, from about 20,000 revolutions per minute (rpm) to about 40,000 rpm and thus starting speed may range from about 4000 rpm to about 12,000 rpm).

During operation of the engine, occasionally a need exists for actuation of a downstream device. Current fuel systems use multiple pumps for engine starting, normal operation (run mode), and actuation. As will be appreciated, multiple pumps add significantly to the overall size and/or weight of the fuel system. Use of a regenerative pumping element, particularly for start-up in a high-speed centrifugal fuel pump system is generally known in the art, for example as shown and described in commonly owned WO 2017/079309 A1 and US 2019/0277233 A1, the entire disclosures of which are hereby expressly incorporated herein by reference.

It would be desirable for a simplified arrangement to direct pressurized flow from the high-speed centrifugal pump while reducing sizing of various system components. Further, it would be advantageous if a single pump could provide the desired output for start-up, run, and actuation modes of a pump system in a compact, efficient manner.

A need exists for an improved arrangement that provides at least one or more of the above-described features, as well as satisfying still other features and benefits.

### SUMMARY

A fuel pump system for supplying fuel from an associated fluid source to an associated downstream use(s) including for engine (i) start mode, (ii) run mode, and (iii) actuation mode is disclosed herein.

In a preferred arrangement, the fuel pump system includes a pump including a primary stage having an inlet and an outlet that are configured to selectively supply pressurized flow for the (ii) run mode. A regenerative stage is commonly driven with the primary stage to selectively provide pressurized fluid for the (i) start mode and the (iii) actuation mode.

The fuel pump system may include a control valve, a regenerative stage control valve, and a pressure regulator valve, where the control valve is in communication with the primary stage for controlling operation thereof.

The fuel pump system may include the control valve in communication with the pressure regulator valve to selectively control fluid flow to the regenerative stage.

The fuel pump system may include the regenerative stage control valve selectively controlling fluid flow from the regenerative stage for the (i) start mode.

The fuel pump system may include the regenerative stage control valve in fluid communication with the outlet of the primary stage such that the regenerative stage control valve selectively closes in response to a preselected pressure at the primary stage outlet.

In a preferred arrangement of the fuel pump system, the pressure regulator valve and the regenerative stage control valve are both open during the (i) start mode.

The pressure regulator valve and the regenerative stage control valve may both be closed during the (ii) run mode.

In a preferred arrangement, the pressure regulator valve is open and the regenerative stage control valve is closed during the (iii) actuation mode.

A first check valve may be provided downstream of the primary stage outlet.

The first check valve may be closed during the (i) start mode.

The first check valve may be open during the (ii) run mode and the (iii) actuation mode.

A second check valve may be provided downstream of the regenerative stage.

The second check valve may be closed during the (i) start mode and the (ii) run mode.

The second check valve may be open during the (iii) actuation mode.

A third check valve may be provided downstream of both the primary stage and the regenerative stage.

The third check valve may be open during the (i) start mode.

Fluid from the regenerative stage may proceed through the regenerative stage control valve and the third check valve in the (i) start mode.

The fuel pump system may include a control valve, a regenerative stage control valve, and a pressure regulator valve, where the control valve may be in communication with the primary stage for controlling operation thereof, the control valve may be in communication with the pressure regulator valve to selectively control fluid flow to the regenerative stage, the regenerative stage control valve may selectively control fluid flow from the regenerative stage for the (i) start mode, and the regenerative stage control valve may be in fluid communication with the outlet of the primary stage such that the regenerative stage control valve may selectively close in response to a preselected pressure at the primary stage outlet.

A method of supplying fuel from an associated fluid source to an associated downstream use(s) including for engine (i) start mode, (ii) run mode, and (iii) actuation mode is disclosed herein.

The method in a preferred arrangement selectively supplies pressurized flow for the (ii) run mode with a pump including a primary stage having an inlet and an outlet that is configured to selectively supply pressurized flow for the (ii) run mode. The method may further include selectively providing pressurized fluid for the (i) start mode and the (iii) actuation mode with a regenerative stage commonly driven with the primary stage.

An improved regenerative pump start mode and actuation stage for a high-speed centrifugal pump is advantageously provided.

Another benefit resides in simplifying the arrangement to direct pressurized flow from the high-speed centrifugal pump.

Another advantage resides in reducing sizes of various system components.

Still another advantage relates to providing a single pump for start-up, run, and actuation modes of the pump system.

Benefits and advantages of the present disclosure will become more apparent from reading and understanding the following detailed description.

### BRIEF DESCRIPTION OF THE DRAWINGS

FIG. 1 is a schematic representation of an engine fuel pump system formed in accordance with the present disclosure where the fuel pump system is illustrated in a start-up mode.

FIG. 2 is a schematic representation of the fuel pump system of FIG. 1 in a run (normal operation) mode.

FIG. 3 is a schematic representation of the fuel pump system of FIG. 1 in an actuation mode.

### DETAILED DESCRIPTION

The following description with reference to the accompanying drawings is provided to assist in a comprehensive understanding of one or more embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. Various exemplary embodiments of the present disclosure are not limited to the specific details of different embodiments and should be construed as including all changes and/or equivalents or substitutes included in the ideas and technological scope of the appended claims. In describing the drawings, where possible similar reference numerals are used for similar elements.

The terms “include” or “may include” used in the present disclosure indicate the presence of disclosed corresponding functions, operations, elements, and the like, and do not limit additional one or more functions, operations, elements, and the like. In addition, it should be understood that the terms “include”, “including”, “have” or “having” used in the present disclosure are to indicate the presence of components, features, numbers, steps, operations, elements, parts, or a combination thereof described in the specification, and do not preclude the presence or addition of one or more other features, numbers, steps, operations, elements, parts, or a combination thereof.

The terms “or” or “at least one of A or/and B” used in the present disclosure include any and all combinations of words enumerated with them. For example, “A or B” or “at least one of A or/and B” mean including A, including B, or including both A and B.

Although the terms such as “first” and “second” used in the present disclosure may modify various elements of the different exemplary embodiments, these terms do not limit the corresponding elements. For example, these terms do not limit an order and/or importance of the corresponding elements, nor do these terms preclude additional elements (e.g., second, third, etc.) The terms may be used to distinguish one element from another element. For example, a first mechanical device and a second mechanical device all indicate mechanical devices and may indicate different types of mechanical devices or the same type of mechanical device. For example, a first element may be named a second element without departing from the scope of the various exemplary embodiments of the present disclosure, and similarly, a second element may be named a first element.

It will be understood that, when an element is mentioned as being “connected” or “coupled” to another element, the element may be directly connected or coupled to another element, and there may be an intervening element between the element and another element. To the contrary, it will be understood that, when an element is mentioned as being “directly connected” or “directly coupled” to another element, there is no intervening element between the element and another element.

The terms used in the various exemplary embodiments of the present disclosure are for the purpose of describing specific exemplary embodiments only and are not intended to limit various exemplary embodiments of the present disclosure. As used herein, the singular forms are intended to include the plural forms as well, unless the context clearly indicates otherwise.

All of the terms used herein including technical or scientific terms have the same meanings as those generally understood by an ordinary skilled person in the related art unless they are defined otherwise. The terms defined in a generally used dictionary should be interpreted as having the same meanings as the contextual meanings of the relevant technology and should not be interpreted as having inconsistent or exaggerated meanings unless they are clearly defined in the various exemplary embodiments.

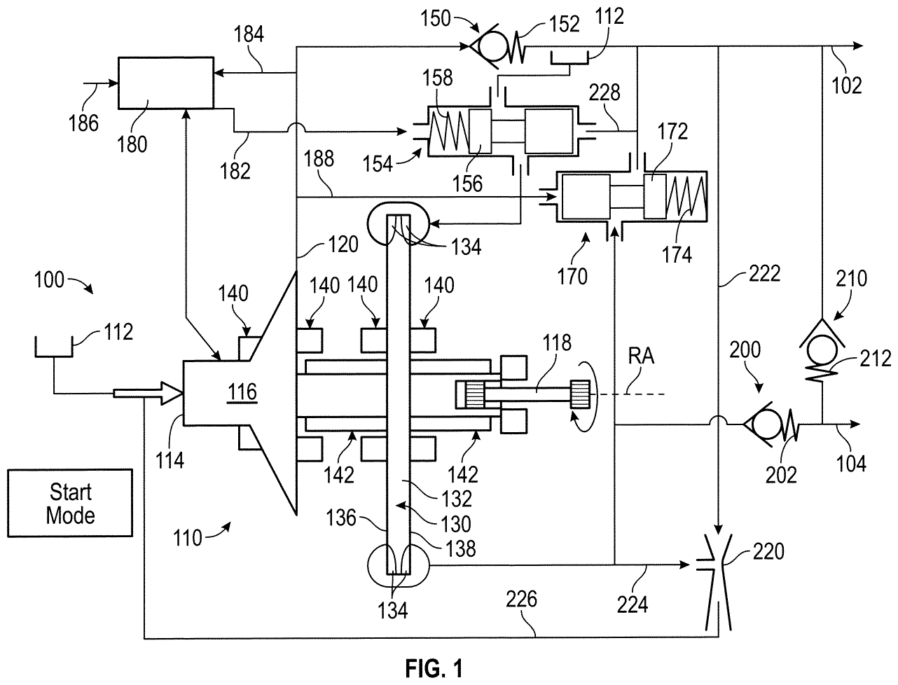

FIGS. 1-3 schematically illustrate the preferred fuel pump system 100 that provides pressurized fuel to a main pump discharge 102 and selectively supplies pressurized fuel for use in connection with one or more downstream uses such as one or more actuators referenced herein as actuator pump discharge 104. The reference numerals provided below refer to the same components in the different figures, although it will be understood that different modes of operation are illustrated in the figures, and the primary areas of distinction are illustrated via the different positions of the various valves that provide for fluid flow through different paths or passages in the system. The pump system 100 includes a pump shown in the preferred arrangement as including a high-speed rotary kinetic pump, specifically a high-speed centrifugal pump 110, that operates on the order of up to 40,000 rpm. The centrifugal pump 110 defines a first or primary stage of the pump system 100. Fluid, which in this particular instance is fuel, is provided from an associated source 112 to pump inlet 114. An inducer/impeller 116 of the centrifugal pump 110 is rotated about a rotational axis RA via a shaft 118 and the impeller thereby boosts the fuel pressure to the desired outlet flow and pressure level at centrifugal pump outlet 120.

A regenerative stage 130 of the pump 110 is commonly driven by the shaft 118. The regenerative stage 130 preferably includes a rotary member or impeller 132 operatively driven by the shaft 118. The rotary member 132 has vanes 134 preferably located adjacent the outer perimeter or periphery of the rotary member, and the vanes are preferably located on both of opposite, first and second faces 136, 138 of the rotary member. Suitable dynamic seals 140 and thrust and journal bearings 142 are provided to seal and support rotational movement of these pump components relative to a pump housing (not shown).

Downstream of the primary stage/centrifugal pump 116 is a first check valve 150. The first check valve 150 is biased toward a closed position by a biasing member such as spring 152. Until the fluid pressure at the pump outlet 120 is sufficient to overcome the biasing force, the first check valve 150 remains closed and therefore pressurized fuel to the main pump discharge 102 must be provided in another manner. Specifically, in the start mode as illustrated in FIG. 1, a pressure regulator valve 154 includes a valve member or spool 156 urged toward an open position by biasing member/biasing spring 158. In the open position of the pressure regulator valve 154 shown in FIG. 1, a path for fuel from a fuel source 112 is provided to supply the regenerative stage 130 of the pump 110. In addition, a regenerative stage control valve 170 includes a valve member or spool 172 that is urged toward an open position by biasing member or spring 174. In addition, electronic control valve 180 is in operative communication with the pressure regulator valve 154 as represented by reference numeral 182 and also in operative communication with the primary stage 116. Still further, the pressure regulator valve 154 receives a signal such as a pressure signal indicative of the outlet pressure from the impeller 116 via line 184 and an external signal such as electrical signal 186. Thus as shown in FIG. 1, in the start mode there is insufficient pressure and flow from the primary stage impeller 116. Consequently, the check valve 150 remains in a closed position during the start mode since the primary stage 116 during start-up generates an insufficient pressure (that creates a force to open the check valve 150) to overcome the closing force of the biasing spring 158. Feedback is also advantageously provided to the electronic control valve 182 by monitoring the build-up of pressure as the impeller 116 begins to rotate faster during start-up.

The electronic control valve 180 provides a suitable signal (e.g., an electrical signal 182) to the pressure regulator valve 154 during the start mode to assure that the pressure regulator valve 154 moves toward the open position shown in FIG. 1. In addition, fluid pressure in path or passage 188 is indicative of the pressure at the primary stage outlet 120 and the fluid pressure is directed to one end of the spool 172 to exert a closing force on the spool. Again, at start-up the pressure from pump outlet 120 is insufficient to overcome the biasing force of spring 174 so that spool 172 is disposed in an open position during start-up and pressurized fluid output from the regenerative stage 130 passes through the regenerative stage control valve 170 and supplies pressurized fluid to the main pump discharge 102. Electrical signal 182 from the electronic control valve 180 is transmitted to the pressure regulator valve 154 which assures that the regenerative stage 130 receives flow from fuel source 112 through the open position of the pressure regulator valve 154. Moreover, the normally open regenerative stage control valve 170 remains in an open position due to insufficient pressure in passage 188 (the pressure in passage 188 urges the spool 172 toward a closed position) so that fluid pressurized by the regenerative stage reaches the main pump discharge 102.

Additionally, a second check valve 200 includes a biasing member or biasing spring 202 that normally closes the second check valve and prevents flow from the regenerative stage 130 from passing through the second check valve to the actuator pump discharge 104.

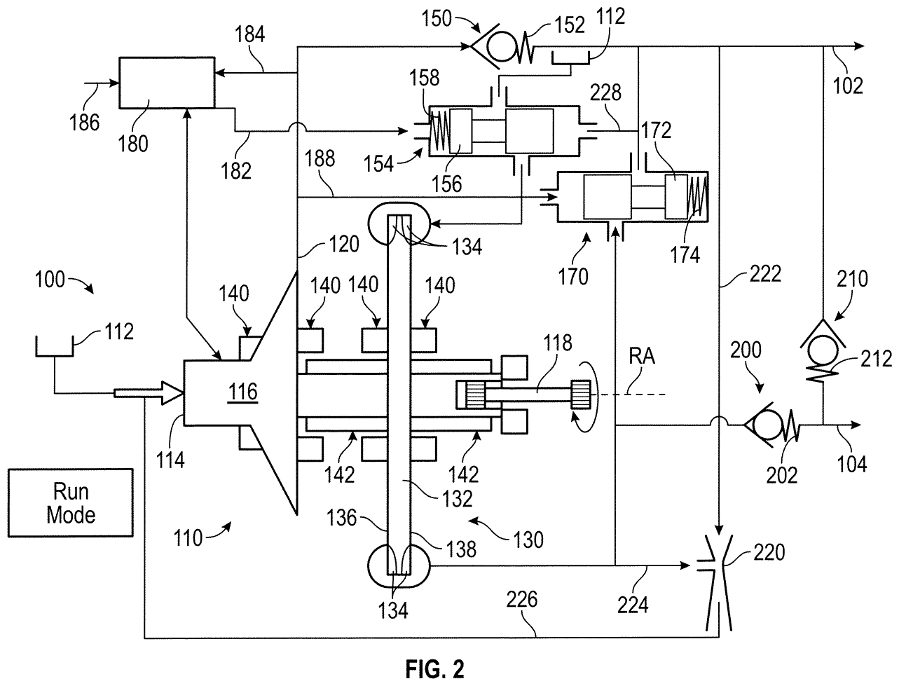

A third check valve 210 is configured to allow flow therethrough toward the actuator pump discharge 104 during the start mode (FIG. 1) and the run mode (FIG. 2). Fluid pressure passing through the third check valve 210 during the start-up and run modes also advantageously aids in maintaining the second check valve 200 in a closed position during these modes of operation.

Still another feature is the inclusion of an ejector 220 in the fuel pump system 100. A portion of the pressurized flow exiting from the regenerative stage 130 during start-up proceeds through branch line 222 to serve as a motive flow source to the ejector 220. This flow through branch line 222 proceeds through the ejector 220 and thereby draws pressurized fluid from branch passage 224 so as to exit the ejector 220 and be returned to the pump inlet 114 of the primary stage 116 via passage 226.

FIG. 2 schematically illustrates the various components of the fuel pump system 100 once the primary stage 116 has reached a rotational speed where sufficient pressure is provided to open the first check valve 150 and supply the main pump discharge 102. More particularly, pressurized flow from the regenerative stage 130 has reached a sufficient elevated state so that pressurized flow in passage 228 (located downstream of the regenerative stage control valve 170) creates a closing force on the spool 156 of the pressure regulator valve 154. Thus, as illustrated, the force created at a right-hand end of the spool 156 is sufficient to overcome the rightward force (as illustrated) imposed by biasing spring 158 whereby the pressure regulator valve 154 is closed. Closing the pressure regulator valve 154 closes the path from the fluid source 112 to the regenerative stage 130. Moreover, the spool 172 of the regenerative stage control valve 170 is moved rightwardly under a force created by sufficient pressure in passage 188 from the primary stage outlet 120 that communicates with the left-hand end of the spool 172 of the regenerative stage control valve 170. This pressure in passage 188 develops a closing force that overcomes the force of biasing spring 174 on the spool 172 so that the regenerative stage control valve 170 is also closed. The first check valve 150 is opened, i.e., the pressure is sufficient to create an opening force that overcomes the normally closed biasing force of spring 152 so that pressurized flow from the primary stage impeller 116 proceeds through the check valve 150 to the main pump discharge 102. Further, a pressure signal in line 184 downstream of the pump outlet 120 provides feedback information to the electronic control valve 180 so that the signal 182 that was communicated to the pressure regulator valve 154 is also terminated during the run mode of the pump system 100.

A portion of the flow to the main pump discharge 102 in the run mode (FIG. 2) is directed through the third check valve 210 to assist in maintaining the second check valve 200 in a closed position. Additional flow can be directed to the actuator pump discharge 104 but that additional flow is insufficient to serve the downstream actuation needs under certain system operating conditions.

As is also evident in FIG. 2, a portion of the flow downstream of the check valve 150 proceeds through passage 222 to the ejector 220. Since the flow from the regenerative stage 130 is closed off, it is desirable to unload the regenerative stage from the pump system 100 since the fluid passing therethrough would otherwise add undesirable heat to the system. At the transition point where the primary or centrifugal stage output pressure begins to provide flow to the main pump discharge 102, flow from the regenerative stage 130 is reduced to zero by flow from the passage 222 passing through the ejector 220 and drawing or scavenging flow from the regenerative stage via line 224, i.e., evacuating the pumping cavity of the regenerative stage 130. Removal of the fluid from the pumping cavity of the regenerative stage 130 results in any of the pumping power consumed by the regenerative stage to be brought near zero, thus effectively decoupling the regenerative stage from the pump system 100. In this manner, pumping capacity for the flow circuit effectively transitions from the regenerative stage 130 to the primary or centrifugal stage 116 to supply the main pump discharge 102.

As is evident in FIG. 2, during the run mode, pressure downstream of the centrifugal pump outlet 120 acts on one end of spool 172 to keep the regenerative stage control valve 170 in a closed position. Further, pressure downstream of the first check valve 150 urges spool 156 of the pressure regulator valve to a closed position via pressure supplied through passage 228 that acts on the right-hand end of the spool.

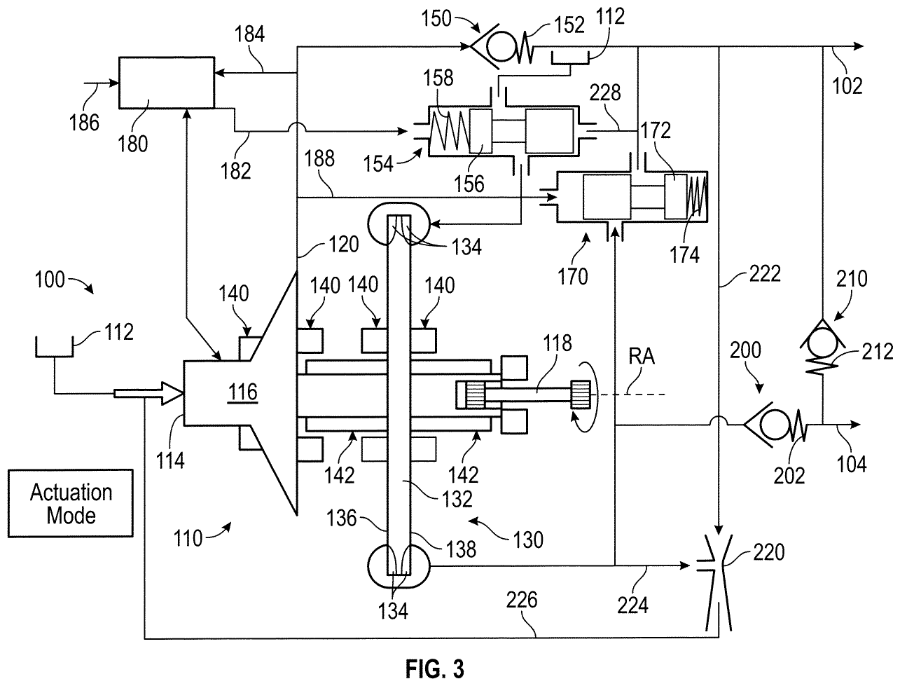

If during the run mode, there is a need for pressure to serve a downstream actuator (not shown) in fluid communication with the actuator pump discharge 104, a signal 182 is provided from the electronic control valve 180 and moves the pressure regulator valve 154 to an open position (FIG. 3—actuation mode). Notably, the regenerative stage control valve 170 remains in a closed position due to the force on the spool 172 as a result of the elevated pressure in passage 188 from the pump outlet 120. The regenerative stage 130 has flow inlet from the fuel source 112 due to the open pressure regulator valve 154. Since the regenerative stage 130 is rotating at an increased speed by the same shaft 118 that drives the impeller 116 of the primary stage, pressurized fluid is now sufficient to overcome the closing force of biasing spring 202 of the second check valve 200. In this manner, the regenerative stage 130 provides pressurized flow through the second check valve 200 to serve the needs of the actuator (or other downstream use) that is in fluid communication with the actuator pump discharge 104. Terminating the electrical signal 182 from the electronic control valve 180 results in closure of the pressure regulator valve 154 (i.e., pressure in line 228 produces a closing force greater than the force of spring 158 that moves the spool 156), and the same process of removing fluid from the cavity of the regenerative stage 130 as described above occurs to remove the regenerative stage from the pump system 100.

This written description uses examples to describe the disclosure, including the best mode, and also to enable any person skilled in the art to make and use the disclosure. Other examples that occur to those skilled in the art are intended to be within the scope of the invention if they have structural elements that do not differ from the same concept or that do not differ from the literal language of the claims, or if they include equivalent structural elements with insubstantial differences from the same concept or from the literal language of the claims. Moreover, this disclosure is intended to seek protection for a combination of components and/or steps and a combination of claims as originally presented for examination, as well as seek potential protection for other combinations of components and/or steps and combinations of claims during prosecution.

Although specific advantages have been enumerated above, various embodiments may include some, none, or all of the enumerated advantages. Although exemplary embodiments are illustrated in the figures and description herein, the principles of the present disclosure may be implemented using any number of techniques, whether currently known or not. Moreover, the operations of the systems and apparatuses disclosed herein may be performed by more, fewer, or other components, and the methods described herein may include more, fewer, or other steps. Additionally, steps may be performed in any suitable order.

To aid the Patent Office and any readers of this application and any resulting patent in interpreting the claims appended hereto, applicants do not intend any of the appended claims or claim elements to invoke 35 USC 112 (f) unless the words “means for” or “step for” are explicitly used in the particular claim.

1. A fuel pump system for supplying fuel from an associated fluid source to an associated downstream use(s) including for engine (i) start mode, (ii) run mode, and (iii) actuation mode, the system comprising:
a pump including a primary stage having an inlet and an outlet that is configured to selectively supply pressurized flow for the (ii) run mode; and
a regenerative stage commonly driven with the primary stage to selectively provide pressurized fluid for the (i) start mode and the (iii) actuation mode.

2. The fuel pump system of claim 1 further comprising a control valve, a regenerative stage control valve, and a pressure regulator valve, the control valve in communication with the primary stage for controlling operation thereof.

3. The fuel pump system of claim 2 wherein the control valve is in communication with the pressure regulator valve to selectively control fluid flow to the regenerative stage.

4. (canceled)

5. (canceled)

6. The fuel pump system of claim 2 wherein the pressure regulator valve and the regenerative stage control valve are both open during the (i) start mode.

7. The fuel pump system of claim 2 wherein the pressure regulator valve and the regenerative stage control valve are both closed during the (ii) run mode.

8. The fuel pump system of claim 2 wherein the pressure regulator valve is open and the regenerative stage control valve is closed during the (iii) actuation mode.

9. The fuel pump system of claim 2 further comprising a first check valve downstream of the primary stage outlet.

10. (canceled)

11. (canceled)

12. The fuel pump system of claim 2 further comprising a second check valve downstream of the regenerative stage.

13. (canceled)

14. (canceled)

15. The fuel pump system of claim 2 further comprising a third check valve downstream of both the primary stage and the regenerative stage.

16. (canceled)

17. (canceled)

18. The fuel pump system of claim 2 further comprising a control valve, a regenerative stage control valve, and a pressure regulator valve, the control valve in communication with the primary stage for controlling operation thereof, the control valve in communication with the (b) pressure regulator valve to selectively control fluid flow to the regenerative stage, the regenerative stage control valve selectively controlling fluid flow from the regenerative stage for the (i) start mode, and the regenerative stage control valve in fluid communication with the outlet of the primary stage such that the regenerative stage control valve selectively closes in response to a preselected pressure at the primary stage outlet.

19. (canceled)

20. A fuel pump system for supplying fuel from an associated fluid source to an associated downstream use(s) including for engine (i) start mode, (ii) run mode, and (iii) actuation mode, the system comprising:
a pump including a primary stage having an inlet, a centrifugal pump stage having an impeller, and an outlet that is configured to selectively supply pressurized flow for the (ii) run mode; and
a rotary member stage commonly driven with the centrifugal pump to selectively provide pressurized fluid for the (i) start mode and the (iii) actuation mode.

21. The fuel pump system of claim 1 further comprising a rotary member control valve, and a pressure regulator valve, and control valve in communication with the centrifugal pump for controlling operation thereof.

22. A method of supplying fuel from an associated fluid source to an associated downstream use(s) including for engine (i) start mode, (ii) run mode, and (iii) actuation mode, the method comprising:
selectively supplying pressurized flow for the (ii) run mode with a pump including a primary stage having an inlet and an outlet that is configured to selectively supply pressurized flow for the (ii) run mode; and
selectively providing pressurized fluid for the (i) start mode and the (iii) actuation mode with a regenerative stage commonly driven with the primary stage.

23. The method of claim 22 further comprising providing a regenerative stage control valve, a pressure regulator valve, and a control valve controlling operation of the primary stage.

24. The method of claim 23 further comprising communicating the control valve with the pressure regulator valve, and selectively controlling fluid flow to the regenerative stage.

25. (canceled)

26. (canceled)

27. The method of claim 23 further comprising opening the pressure regulator valve and the regenerative stage control valve during the (i) start mode.

28. The method of claim 23 further comprising closing the pressure regulator valve and the regenerative stage control valve during the (ii) run mode.

29. The method of claim 23 further comprising opening the pressure regulator valve and closing the regenerative stage control valve during the (iii) actuation mode.

30. The method of claim 23 further comprising locating a first check valve downstream of the primary stage outlet.

31. (canceled)

32. (canceled)

33. The method of claim 23 further comprising locating a second check valve downstream of the regenerative stage.

34. (canceled)

35. (canceled)

36. The method of claim 23 further comprising locating a third check valve downstream of both the primary stage and the regenerative stage.

37. (canceled)

38. (canceled)

39. The method of claim 23 further comprising providing a regenerative stage control valve, a pressure regulator valve, and a control valve in communication with the primary stage, and controlling operation of the primary stage with the control valve, and selectively controlling fluid flow to the regenerative stage, the regenerative stage control valve selectively controlling fluid flow from the regenerative stage with the pressure regulator valve the (i) start mode, and selectively closing the regenerative stage control valve with the outlet of the primary stage such that the regenerative stage control valve selectively closes in response to a preselected pressure at the primary stage outlet.

40. (canceled)
